(19) United States
(12) Patent Application Publication
(10) Pub. No.: US 2005/0257878 A1
(43) Pub. Date: Nov. 24, 2005

(54) Radio frequence drying for use in core and tubewinding operations

(76) Inventors: Christopher Scott Thomas, Plainfield, NJ (US); Peter D. Pierce, Washington Crossing, PA (US); Christian E. Russell, High Bridge, NJ (US)

Correspondence Address: Cynthia L. Foulke;Intellectual Property, NATIONAL STARCH AND CHEMICAL COMPANY, 10 Finderne Avenue, Bridgewater, NJ, 08807-0500, US

(21) Appl. No.: 10/849,342

(22) Filed: May 19, 2004

(51) Int. Cl. B31C 1/00

(52) U.S. Cl. 156/195; 493/276; 493/299; 493/274

(57) ABSTRACT

An apparatus and method for manufacturing a core or tube using radio frequency. When using aqueous-based adhesives, application of radio frequency allows for a much more efficient and much quicker method for drying and curing.

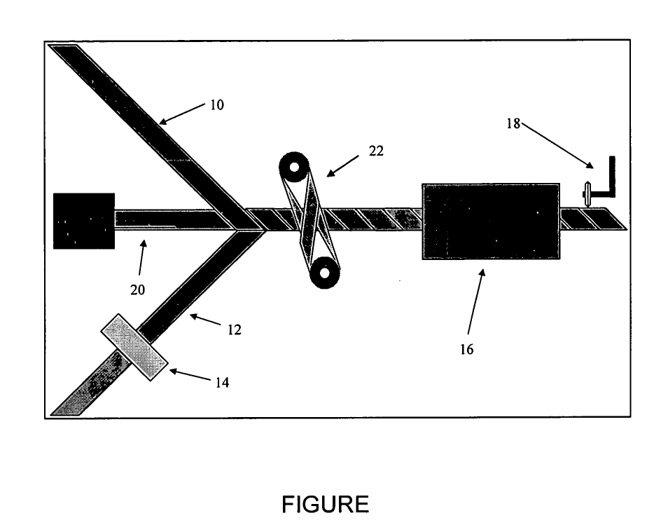

### FIELD OF THE INVENTION

The invention relates to the field of core and tubewinding. More particularly, the invention relates to the use of radio frequency to facilitate the drying of waterborne adhesives used in core and tubewinding operations.

### BACKGROUND OF THE INVENTION

Paper tubes for use as winding cores, composite cans or tubes for packaged goods, concrete forms, etc. are generally produced from two or more plies of paper, fed either by a web or from a stack of precut sheets. Adhesive is applied between the plies, and the paper is then wound around a stationary steel mandril. Belts twisted around the mandril and plies provide compression and drive the process, pulling the webs and feeding the wound tube forward. At some point located past the end of the steel mandril, the wound tube is cut, and the finished tube is then ready for use or for the next step in a converting process.

While the limiting factor in this process has historically been the speed of the equipment, increased demand for higher output of the converting equipment, and improvements in equipment engineering and fabrication, have now made the adhesive systems—almost exclusively waterborne adhesives in North America—the limiting factor in the converting process. Specifically, it is necessary that the applied adhesive be properly “set” by the time the tube is cut and further handled or processed. For this to happen, enough water must be removed from the adhesive itself (through absorption or evaporation, or a combination of the two) to form a sufficiently strong and cohesive bond. Due to the speeds of newer and faster equipment, there is not enough time available in the process between the adhesive application and the cutting station for this to occur, and so machine speed must be slowed down.

Aside from the conventional “unaided” converting process, methods of removing water from the adhesive system, include hot-air blowers, ovens using heating elements, hot presses or forms that intimately contact the wound tube, heat lamps and other infrared heating methods, and microwave irradiation. Drying methods employing heated parts, hot air, and infrared lamps are often very inefficient processes since most of the energy used in creating the heat is “wasted” due to environmental loss and the necessity of transferring the heat through the substrate(s) and into the adhesive layer.

A problem inherent in many of these methods is that they must also provide heat to the paper plies. This is unavoidable, since many of these methods of transferring heat to the adhesive cannot reach the adhesive layer without first heating the outer layer(s) of paper. The energy of heating is transferred to the entire wound tube; this can affect the moisture content of the paper quite radically by drying the paper in the process of heating the tube. Once the moisture content of the paper in the finished tube re-equilibrates with the surrounding environment, the tube may shrink, expand, warp, or otherwise deform, which often makes the tube unsuitable for further use or processing. In addition, proximity to high heat sources (such as infrared lamps or heated elements) can cause physical damage (such as scorching) to the plies themselves.

Many other methods of heating and drying the adhesive also increase the temperature of the area and equipment surrounding the process. Hot-air blowers and oven elements generate a great deal of heat, posing a potential safety hazard. In many cases, because of the amount of heat necessary to affect the desired level of drying, the work area may become uncomfortably warm or even hazardously hot. Equipment (particularly the equipment generating the heat) may become dangerous to touch. The risk of ignition or other fire-related issues is also increased in such circumstances.

A need exist for alternative methods of manufacturing cores and tubes to enable the faster, more economical and safer production thereof. The current invention fulfills this need.

### SUMMARY OF THE INVENTION

The invention provides a paper core or tube comprising one or more plies of paper or paperboard bonded together with an adhesive that has been dried using radio frequency emission.

One embodiment of the invention is directed to a method of preparing a single or multi-ply core or tubular container having at least a first ply wrapped into a tubular shape and having an inner surface and an outer surface. The core or tubular container may further comprise at least a second ply wrapped into a tubular shape and having an outer surface positioned in face-to face contact with the inner surface of the first ply. At least one of the plies is formed of a fibrous paperboard. A water-based adhesive is placed between the inner surface of the first ply and the outer surface of the second ply to adhere the two plies together. The adhesive is then dried using radio frequency. The core may desirable include additional body plies, e.g. up to about 30 plies or more.

Another embodiment of the invention is directed to a method of manufacturing multiply cores or tubular containers. The method comprises advancing a continuous first ply and continuous second ply towards a shaping mandril wherein at least one of those plies comprises a body ply formed of fibrous paperboard. A water based adhesive composition is then applied to at least one surface of the first and second plies. In that manner, the first and second plies are adhered together with the adhesive. The first and second plies are wrapped around the shaping mandril to create the core. The first and second plies may be adhered together by passing the two plies in face-to face contact prior to the wrapping step or they may be adhered during the wrapping stage. The core is then passed through radio frequency waves to dry the adhesive.

Yet another aspect of the invention is directed to an apparatus for manufacturing a multi-ply core or tube. The apparatus includes an adhesive applicator for supplying an adhesive. The adhesive applicator is located adjacent to one surface of a body ply and applies the adhesive to the surface of the body ply. The body ply may be supplied in the form of continuous body ply material. A shaping mandril is positioned to allow the plies to be adhered together with the adhesive to form the two plies into a tubular shape. The apparatus also contains a radio frequency unit for drying the adhesive. Advantageously, the apparatus further includes a cutting station for cutting the tubular shape into discrete container lengths. Preferably, the radio frequency drying unit is placed after the mandril and before the cutting saw.

### BRIEF DESCRIPTION OF THE DRAWING FIGURE

The drawing FIGURE illustrates one type of an apparatus for manufacturing tubular containers or cores, which apparatus provides a means for radio frequency assisted curing. In the apparatus diagramed, the radio frequency unit is placed after the mandril and before the cutting saw, with the uncut core passing through the unit and hence through the radio frequency field.

### DETAILED DESCRIPTION OF THE INVENTION

The process of manufacturing cores and tubes with waterborne adhesive can be greatly accelerated by irradiating the application or bond area with radio frequency waves of sufficient energy and appropriate character. The use of a radio frequency dryer allows core winding equipment to be run at higher machine speeds, increasing the total output of finished product.

While the use of radio frequency emissions to effect heating in materials containing at least some water is known and has been used in a number of industries and applications, radio frequency-assisted curing has not heretofore been used in tube and core-winding applications.

Radio frequency drying makes use of the dielectric nature of water in order to effect a transfer of energy and cause an object containing water to be heated. When water is subjected to radio frequency emissions, the molecules align in the presence of the field, and then re-align as the radio frequency wave oscillates. This occurs at a rate that is equal to the frequency of the emission—meaning that if the energy is being emitted at 40 MHz, or forty million wave-cycles per second, then the water molecules are re-aligning forty million times per second. This increase in kinetic energy leads to an overall increase in the energy state of the water, causing the temperature of the water to rise dramatically.

In the practice of the invention, the natural dielectric effect of water is used to increase the internal energy of the adhesive thereby causing the temperature of the adhesive to rise. This causes the adhesive to film-form, set, and dry much more quickly than without. In addition, this effect can also cause any temperature-sensitive components of the adhesive to activate and perform an intended function. The process of the invention allows for much greater process speed for tube and core winding.

The invention provides a method and apparatus for manufacturing cores and tubes which makes use of radio frequency. Useful radio frequency bands are ISM (Industrial, Scientific, Medical) bands including 6.765-6.795 MHz, 13.553-13.567 MHz, 26.957-27.283 MHz, 40.66-40.70 MHz, 902-928 MHz, 2400-2500 MHz. As would be apparent to the skilled practitioner, the radio frequency unit is tailored to the speed, amount of adhesive, size of the system, i.e., width of unit or exposure area, and the power/energy of the generator.

The manufacture of both consumer (e.g., toilet paper rolls, food containers, and the like) and industrial (e.g., concrete forms, spool for cable wire, and the like) cores and tubes are encompassed by the invention. As used herein, a core is a paper or paperboard construction around which material may be wound. The material can be tissue or towel, carpet, textile, plastic film, paper or any other material that is would around a core. A tube is a container that is used to transport or store various dry foods, refrigerated foods or dough, oils and other liquids and is also used for various industrial applications, e.g., concrete column forming tubes, caulking tubes.

Cores or tubes can be made using single or multiple plies of substrates. Typically about 2 to about 7 plies are used in cores/tubes for consumer applications and from about 10 to about 20 plies or more are used in cores/tubes for industrial applications.

When making paper cores or tubes in accordance with the invention, the selection and application of the adhesive is not critical to the practice of the invention. Useful adhesives include any conventional “aqueous-based,” “water-based” or “waterborne” adhesive conventionally used for paper core/tube manufacture. Non-limiting examples include natural polymer solutions, synthetic polymer solutions and synthetic polymer emulsions, such as polyvinyl acetate homopolymer or copolymer emulsions (neat or formulated with other components), polyvinyl alcohol, dextrins, starches, acrylates, silicates, filled systems and crosslinkables. Adhesive formulations will optionally contain conventional additives such as preservatives, defoamers, cross-linking agents, strength additives, fillers and surfactants. The adhesive may be applied, if desired, in a foamed state.

There are two basic methods for making a core, convolute winding and spiral winding. Convolute winding uses a web of paper that is as wide as the resulting core is long. A mandril spins and winds the paper onto itself forming the core. The adhesive is continuously applied to the ply material as the core is wound. Spiral winding comprises continuous winding of 2 or more plies around a mandril at an angle causing the length of the core to grow as the plies are wound. The adhesive is continuously applied to the ply material as the core or tube is wound. Methods and of preparing helically wound cores/tubes and “convolute” cores/tubes are encompassed by the invention.

The drawing FIGURE illustrates a two-ply spiral-wrap tube winding apparatus that may be used in the practice of the invention. In this configuration, a core/tube is produced from two plies of paper fed either by a web or from a stack of precut sheets. Adhesive (14) is applied between the inner ply (10) and outer ply (12), and the paper is then wound around a stationary mandril (20). Belts (22) twisted around the mandril and plies provide compression and drive the process, pulling the webs and feeding the wound tube forward. A radio frequency unit (16) is located after the mandril and before the cutting saw (18). The uncut core passes through the unit and hence through the radio frequency field. At a point located past the end of the mandril, the wound tube is cut by the cutting saw, and the finished tube is then ready for use or for the next step in a converting process.

It is to be understood that the invention is not limited to this particular configuration exemplified in the FIGURE, and that other configurations are contemplated and are encompassed by the invention. For example, in the FIGURE, adhesive is applied to the inner surface (i.e., the bonding surface) of the outer ply using an open or roller pot. Using cascade adhesive application, adhesive is conventionally applied to the outer surface (i.e., the bonding surface) of the inner ply. Radio frequency drying can be applied to other tube- and corewinding configurations, including much higher ply count applications, convolute or non-spiral tubewinding, non-paper substrates, etc.

Water based adhesives must dissipate water before a bond can be formed. The water dissipates due to evaporation and/or absorption into the substrates (plies), and in the process the adhesive becomes tacky. While an adhesive with the least amount of water is the most desired, a water based adhesive must comprise enough water so when applied the adhesive is sufficiently wet at the time of contact to ensure that both plies to be bonded together are wetted by the adhesive. This dichotomy, of the adhesive being wet enough to affect the surfaces of the plies, but not too wet such that the bond takes a long time to form, has been and continues to be a concern for the core and tube construction industry. In core and tube construction, as the winder speed is increased, the amount of time for water to dissipate decreases. Without adjustments by the operator of the machinery to reduce the amount of adhesive applied, or to decrease machine speed, the wet adhesive layer can cause ply slippage and shutdown, or “dog ears” at the cut off saw. The term “dog ears” refers to ply separation during the core cutting stage; the ply typically folds back upon itself resembling a dog's ear. By locating a radio frequency unit e.g., after the mandril and before the cutting saw, the uncut core passes through the unit and hence through the radio frequency field. This procedure overcomes problems that occur when the core is cut while the adhesive film is still wet and not completely set, and allows finished cores/tubes to be produced faster.

It has been found, in accordance with the present invention, that radio frequency assisted drying of water-based adhesives used in the manufacture of paper tubes and cores overcomes some of these problems as well as providing a more attractive and effective method of increasing the speed of the process than traditional heating methods (including infrared radiation, hot-air dryers, or heated-element ovens). Radio frequency drying is also more effective, more efficient, and safer than microwave drying, because of the inherent differences in wavelength and energy of the emissions.

When applied to corewinding, radio frequency drying allows for process improvements that can yield faster and more efficient output and greater control. It also allows a process to continue to use water-based adhesives and coatings without concern for the typical limitations associated with such materials, such as the slow evaporation rate of water compared to solvents, or the slower “set speed” of water-based adhesives to solvent-borne systems or thermoplastic hot-melt adhesives. The net result is a faster, more efficient, and more controlled converting process that is cost-effective and environmentally sound.

The invention provides a method of preparing a single or multi-ply core or tubular container. The core or tube comprises at least a first and, preferably, at least a second ply. The core/tube is formed by applying a water-based adhesive between the inner surface of the first ply and the outer surface of the second ply to adhere the two plies together. At least one of the plies is formed of a fibrous paperboard. The adhesive is then dried using radio frequency. The core may desirably include additional body plies. Typically about 2 to about 7 plies are used in cores/tubes for consumer applications and from about 10 to about 20 plies or more are used in cores/tubes for industrial applications.

The invention provides a method of manufacturing multi-ply cores. The method comprises advancing a continuous first ply and continuous second ply towards a shaping mandril wherein at least one of the plies comprises a body ply formed of fibrous paperboard. A water-based adhesive composition is then applied to at least one surface of the first and second plies. In this manner, the first and second plies are adhered together with the adhesive. The first and second plies are wrapped around the shaping mandril to create the core. The first and second plies may be adhered together by passing the two plies in face-to face contact prior to the wrapping step or they may be adhered during the wrapping stage. The core is then passed through a radio frequency apparatus to dry the adhesive.

The invention also provides an apparatus for manufacturing a core/tube. The apparatus includes an adhesive applicator for supplying an adhesive. The adhesive applicator is located adjacent to one surface of a body ply and applies the adhesive to the surface of the body ply. A shaping mandril is positioned to adhere the plies together with the adhesive to form a tubular shape. The apparatus further a radio frequency unit for drying the adhesive. Advantageously, the apparatus further includes a cutting station adjacent to one end of the mandril for cutting the tubular shape into discrete container lengths. The radio frequency unit is preferable placed between the mandril and the cutting station.

Radio frequency drying provides a nearly instantaneous set of the water-based adhesive. By passing the wound tube through an radio frequency dryer, the water contained within the adhesive layer can be heated and evaporated in a fraction of the time otherwise required to remove the water (through normal drying and/or absorption inherent in the process). Use of radio frequency drying compared to the conventional process removes the adhesive as being the limiting factor in core/tube winding applications.

Radio frequency drying is a much more energy-efficient means of heating the adhesive, as the radio frequency wave will pass through air and substrate with little or no loss of energy to the surroundings. Additionally, power consumption in radio frequency drying can be tightly controlled, using only as much energy as is necessary to dry the amount of adhesive used in the converting process, without the need to overcompensate for a high degree of loss of energy to the environment. This energy efficiency also makes radio frequency drying much more environmentally sound than other methods of drying. By comparison, radio frequency drying does not negatively impact the paper, since paper does not exhibit sufficient dielectric character to be receptive to the energy carried by the radio frequency waves. Only those portions of the wound tube which contain significant amounts of water, such as the adhesive layer, are heated; this avoids causing physical changes or damage to the wound tube itself. Radio frequency drying avoids this by transferring energy only to receptive materials and through simple and effective shielding commonly used in the application of radio frequency drying. Moreover, radio frequency drying does not create an excess of ambient heat.

Radio frequency drying also can enable much higher production speeds than other drying methods. Since the radio frequency wave passes through the paper easily, there is no need for additional process “dwell time” to allow for the entire wound tube to be heated sufficiently. Instead, the energy is passed directly to the water in the adhesive layer and the receptivity of the water to radio frequency energy makes nearly instant drying of the adhesive possible. This would allow for converting processes that are faster, require less time, and have a smaller floor-space “footprint.” Radio frequency drying is a much better alternative with regards to the quality of the finished product, the safety of the process operators, the environmental impact, and the efficiency and speed of the process. While both radio frequency and microwave radiation both are forms of electromagnetic energy, and both exploit the same dielectric character of water to achieve internal heating, radio frequency energy is lower in frequency and longer in wavelength than energy in the microwave region. This makes it more energy efficient in terms of heating the water, and safer for general use since higher frequency energy is more likely to have potentially damaging effects on the organs and tissues of living things—including the equipment operators—and is more difficult to shield and contain.

It has been discovered that radio frequency drying in tube- and corewinding operations enables a substantial increase in process speeds by removing the drying speed of the adhesive as the limiting factor in the converting process. This can be achieved in a safe and environmentally sound manner, without requiring significant process changes or re-engineering, and without an increased chance of physical change or damage to the finished tube or core.

The invention is further illustrated by the following non-limiting examples.

### EXAMPLES

In the following examples, different adhesive formulations were evaluated on conventional core winding machinery. The core stock used in all tests was “30# Blue Chip Core Stock”, 3.27″ wide, 0.010″ thick, from US Paper Mills. The corewinding machine had a maximum speed of 450 core FPM (100%). The glue roll to doctor blade gap was 0.005″.

A polyvinyl alcohol-stabilized waterborne emulsion of ethylene vinyl acetate (adhesive Sample 1) was evaluated. This adhesive was a high solids (58% solids by weight), fast setting formula with a viscosity of 1800 cPs. A medium solids, repulpable EVA adhesive, specifically designed for corewinding and available under the tradename CORETITE® from National Starch and Chemical Company (adhesive Sample 2), and a polyvinyl acetate emulsion with a viscosity of 1500 cPs available under the tradename RESYN® from National Starch and Chemical Company (adhesive Sample 3) were also evaluated.

In each case, the core was produced while initially running the machine at 25% operating speed (approximately 110 feet per minute (FPM)), slowly increasing the operating speed until the machine was not able to produce a finished core without defects or until top operating speed was reached. Defects, which would constitute a “failure”, include dog ears, ply slippage, or cores, which become crushed or flattened during the cutting process. Each sample was tested, both with and without the aid of the radio frequency drying unit.

The results observed are shown in Table 1.

TABLE 1

| | Maximum speed | | Maximum speed | |
|---|---|---|---|---|
| Adhesive | (with RF) | Strength | (without RF) | Strength |
| Sample 1 | 450 FPM | High | 310 FPM | Moderate |
| Sample 2 | 450 FPM | High | 350 FPM | Moderate |
| Sample | 450 FPM | High | 250 FPM | Moderate |

In the above tests, 100% winder speed was achieved with all samples using radio frequency drying; in each of these cases, the core produced was dry, firm, and strong. In contrast, those cores produced at the highest possible speed without radio frequency drying did not have as high a strength, and had a higher moisture content, and were produced at lower operating speeds.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

1. A method for preparing a paper or paperboard core or tube comprising bonding together one or more plies of paper or paperboard material with a water-based adhesive and drying the adhesive with radio frequency.

2. The method of claim 1 wherein the core or tube is a single ply core or tube.

3. The method of claim 1 wherein the core or tube is a multi-ply core or tube.

4. The method of claim 1 wherein the core or tube is a consumer core or tube.

5. The method of claim 1 wherein the core or tube is an industrial core or tube.

6. The method of claim 1 wherein the core or tube is used in the tissue, towel, carpet, textile, plastic film, paper, food or industrial storage industry.

7. The method of claim 6 wherein the tube is a tubular container.

8. The method of claim 6 wherein the tubular container is a food container.

9. The method of claim 1 wherein the adhesive is applied to the ply material as the core or tube is wound, the wound core or tube is passed through a radio frequency field, and the core or tube is cut to a desired length.

10. The method of claim 5 wherein the tube is a concrete column forming tube.

11. The method of claim 10 wherein the concrete column forming tube comprises from about 10 to about 30 plies.

12-20. (canceled)
